(19) United States
(12) Patent Application Publication
(10) Pub. No.: US 2012/0145259 A1
(43) Pub. Date: Jun. 14, 2012

(54) Mesh for Screening a User from Direct Impact of a High Pressure Fluid by Diffusing the Fluid Stream

(76) Inventors: Andrew Piggott, Merewether (AU); David Leslie Weston, Swansea (AU)

(21) Appl. No.: 12/991,645

(22) PCT Filed: May 8, 2009
(86) PCT No.: PCT/AU2009/000583

§ 371 Date: Jan. 13, 2011

(30) Foreign Application Priority Data
May 8, 2008 (AU) 2008902244

(51) Int. Cl. F16P 1/00

(52) U.S. Cl. 137/377

(57) ABSTRACT

A mesh (10) for use in screening a user from direct impact of a high pressure fluid J is adapted for receiving and diffusing S the high pressure fluid therethrough when positioned in relation to a location P from which the high pressure fluid issues. The mesh (10) can form part of a screening apparatus that comprises a frame (72) for supporting the mesh in a spaced relationship to the location P from which the high pressure fluid issues. The mesh and apparatus can be employed in a method in which the high pressure fluid is diffused at a first location that is spaced with respect to a second location from which the high pressure fluid issues.

### TECHNICAL FIELD

Disclosed is a method and apparatus for the screening of high pressure fluids, especially hydraulic fluids, and especially in mining (e.g. underground) and civil construction, and related applications. However, it should be appreciated that the method and apparatus can readily be adapted for use in the many other applications of high pressure fluids.

### BACKGROUND ART

Hoses, pipes and tubes that carry high pressure fluids can be prone to rupture, especially when they are required to be formed from a flexible material for a given application. Machinery and tools that are powered by hydraulic fluid (e.g. as employed in underground mining, civil construction and related applications) can be supplied with hydraulic fluid in hoses, lines, etc at pressures of 5000-6000 psi or even greater. Should a hose rupture occur that takes the form of a small so-called “pinhole”, the issuing jet of fluid can have a needle-like profile. Such a fluid jet can function like a lance or needle and can penetrate/pierce right through a human body, resulting in death or serious injury. In this regard, when the injury is not fatal, the high pressure fluid can nevertheless flow into and through the body cavities, and can destroy the veins, arteries, muscles, ligaments and other passages in the human body.

Attempts have been made in the art to prevent a jet of fluid issuing from high pressure fluid carrying hoses that rupture in use. These attempts have centred around either a structural reinforcing of the hose itself or a sheathing to capture an issuing jet of fluid.

For example, WO 2003/31455 discloses a woven stocking for surrounding a high pressure hose and that is adapted to retain fluid that issues from a hose rupture within an envelope surrounding the hose.

Similarly, WO 2001/42703 discloses a woven porous sleeve that surrounds a hose. The sleeve includes cables projecting therefrom to be connected to anchoring points to prevent hose lashing and flailing after hose rupture. The sleeve also functions to retain hydraulic fluid therein in the case of rupture.

A reference herein to a prior art document is not an admission that the document forms a part of the common general knowledge of a person of ordinary skill in the art in

### SUMMARY OF THE DISCLOSURE

In a first aspect there is provided a mesh for use in screening a user from direct impact of a high pressure fluid, the mesh being adapted for receiving and diffusing the high pressure fluid therethrough when positioned in relation to a location from which the high pressure fluid issues.

In one form the mesh can assume the form of a panel that has a spaced relationship to the location from which the high pressure fluid issues. In this form the mesh can be adapted for being mounted to a frame.

In an alternative form the mesh can assume the form of a sleeve that can be closely positioned to the location from which the high pressure fluid issues (e.g. a sleeve positioned to surround a high pressure fluid line in a close facing relationship).

In a second aspect there is provided screening apparatus for screening a user from direct impact of a high pressure fluid, the apparatus comprising:
a mesh arranged and adapted for receiving and diffusing the high pressure fluid therethrough; and
a frame for supporting the mesh in a spaced relationship to a location from which the high pressure fluid issues.

It has been discovered that if a high pressure fluid (such as a hydraulic fluid at 5000 psi or greater) is attempted to be restrained at or by a woven sleeve or stocking that surrounds a hose, pipe or tube that carries the high pressure fluid, the sleeve/stocking material can readily rupture, whereby a pinhole jet of fluid can still issue from the hose, pipe or tube.

However, it has been surprisingly discovered that if a high pressure fluid is allowed to pass through a mesh and is also caused to diffuse at the same time, then both the fluid's energy and the pinhole fluid jet itself can be dissipated/dispersed. In this regard, the mesh can be selected and adapted such that, rather than restraining the fluid, it allows it to pass but at the same time diffuses it.

Thus, the death from pinhole fluid injection into a user can be eliminated. Injury from fluid contact can also be eliminated or substantially ameliorated (though in the latter case, provided that protective clothing and eyewear is being worn to protect against diffused fluid).

In one form the mesh is formed from metal wire, to provide dimensional stability, environmental resistance and robustness in industrial applications. The mesh is usually woven. Whilst it is conceivable that at some (e.g. lower) fluid pressures that a polymer or other material mesh may be considered, in industrial applications metal meshes are favoured. In one embodiment, for example, in applications where there exists high levels or moisture or corrosive media, the mesh can be formed from stainless steel wire, though other corrosion resistant metals can be employed for the mesh (e.g. such as copper, galvanised steel wire etc).

Especially for hydraulic fluid at high fluid pressures (e.g. around 5000 psi or greater) the mesh aperture size can be selected to be around 0.25 mm or greater. For hydraulic fluid at higher fluid pressures (e.g. around 6000 psi or greater) the mesh aperture size can be selected to be around 0.3 mm or greater. It has been observed that when an aperture size of less than 0.25 mm is employed then the mesh can restrict fluid flow therethrough to the point where resultant back-pressure can cause the mesh to rupture. It has also been observed that when an aperture size that is considerably greater that 0.3 mm is employed then the mesh does not function to sufficiently diffuse the pinhole jet of fluid, whereby the fluid can retain its energy and human injury can still result. Thus, mesh size selection involves due consideration and optimisation to produce a diffusion effect for the given fluid, the given fluid pressure, the likely rupture scenario and the given application.

An optimal aperture size range for a hydraulic fluid at a pressure of around 5000 psi has been observed to be 0.26-0.31 mm, optimally in a woven stainless steel mesh. Also, when the mesh aperture size is 0.26 mm an optimal wire diameter has been observed to be 0.16 mm, and when the mesh aperture size is 0.31 mm an optimal wire diameter has been observed to be 0.2 mm.

An optimal aperture size range for a hydraulic fluid at a pressure of around 6000 psi has been observed to be 0.31-0.415 mm, optimally in a woven stainless steel mesh. Also, when the mesh aperture size is 0.31 mm an optimal wire diameter has been observed to be 0.2 mm, and when the mesh aperture size is 0.415 mm an optimal wire diameter has been observed to be 0.22 mm.

When the mesh is in the form of a panel, the entire panel or edge(s) of the mesh can optionally be reinforced for fastening with respect to the frame. This can allow the mesh to be adequately supported at a remote location, and restrained and stabilised for fluid impact, and to resist other inadvertent impacts. For example, the entire panel or at least the edge(s) of the mesh can be reinforced with a polymeric rubber that is attached (e.g. moulded, adhered, cold-rolled etc) thereat. The mesh can also be provided with a series of holes (e.g. eyelets) along it edge(s) for enabling its fastening to the frame (e.g. by bolting, tying, staple toggles etc).

When the entire mesh is coated on one or both sides with the polymeric rubber this can provide for maximum mesh protection during ordinary use. Then, at high pressure fluid impact, the rubber coating can simply disintegrate to expose the mesh, with fluid diffusion still occurring as the fluid travels through the mesh. The polymeric rubber can be vulcanised. A particular suitable rubber is vulcanised and calendered styrene butadiene rubber (SBR) because of its high tensile strength, abrasion resistance, and moderate ozone and ageing resistance.

In one form the frame can be arranged at and/or can form part of a cage for screening the user in use.

Whilst the location from which the high pressure fluid issues can typically comprise a hole (e.g. a pinhole) in a high pressure hose, pipe or tube, the high pressure fluid can issue forth from other sources, such as leakages in pipe/tube couplings and joiners, from hydraulically or pneumatically powered equipment itself, from pumps etc. Thus, the mesh can be sized and/or shaped for positioning in relation to such apparatus/sources.

When the location from which the high pressure fluid issues is a high pressure hose, pipe or tube, the high pressure fluid can be a hydraulic fluid (e.g. a fluid formed from a synthetic compound, from a mineral oil, from water, or from a water-based mixture), with the fluid being at a pressure of around 5000 psi or greater in use. The fluid may alternatively comprise a high pressure gas, or another pressurised liquid not necessarily being employed to power hydraulic equipment.

In a third aspect there is provided a method for screening a user from direct impact of a high pressure fluid, the method comprising the step of diffusing the fluid at a first location that is spaced with respect to a second location from which the high pressure fluid issues.

As with the screening apparatus and panel of the first and second aspects, when a high pressure fluid is caused to diffuse at a first spaced location, then both the fluid's energy and e.g. a pinhole fluid jet can be dissipated/dispersed. In this regard, the method of the third aspect can employ the screening mesh or apparatus of the first and second aspects.

In the method of the third aspect the first location can be closely spaced with respect to the second location (e.g. when a mesh is employed for diffusing the fluid and assumes the form of a sleeve that is closely positioned around e.g. a fluid line). Alternatively, the first location can be remotely spaced with respect to the second location (e.g. when the mesh is employed that assumes the form of a panel that in turn is e.g. mounted to a frame).

In the method of the third aspect a mesh can be positioned at the first location such that the mesh receives and diffuses the high pressure fluid therethrough. The mesh can be supported by mounting it to a frame. Such a frame can be arranged at a cage that at least partially surrounds the user in use. In this way, a user can be protected from catastrophic injury whilst working in the vicinity of high pressure fluid lines.

With the method of the third aspect, the mesh aperture size can be selected to be suitable for a given fluid, so as to optimise high pressure fluid diffusion through the mesh. For example, for a high pressure hydraulic fluid at a pressure of around 5000 psi, the mesh aperture size can be selected to be around 0.25 mm or greater (e.g. in the range of 0.26-0.31 mm). For a high pressure hydraulic fluid at a pressure of around 6000 psi, the mesh aperture size can be selected to be around 0.3 mm or greater (e.g. in the range of 0.31-0.415 mm).

With the method of the third aspect, the mesh material can also be selected to be suitable to the given application. For example, in wet and/or corrosive environments the mesh can comprise stainless steel wire woven into a mesh form. Stainless steel is also washable. Other metals that are resistant to corrosive media and moisture can alternatively be employed for the mesh.

In the method of the third aspect, when the location from which the high pressure fluid issues is a hole (e.g. a pinhole) in a high pressure hose, pipe or tube, the diffusion can be effected closely (e.g. sleeve) or remotely (e.g. panel) from the hose, pipe or tube. The mesh positioning that is ultimately selected can take into account whether the mesh needs to be suitably supported and located either remotely or closely with respect to where a user is operating.

### BRIEF DESCRIPTION OF THE DRAWINGS

Notwithstanding any other forms which may fall within the scope of the apparatus and method as set forth in the Summary, a number of specific embodiments will now be described, by way of example only, with reference to the accompanying drawings in which:

FIG. 1 shows a front view of a first mesh panel embodiment, with the FIG. 1A inset detailing the mesh of the panel;

FIG. 2 shows the mesh panel embodiment of FIG. 1, but with a polymeric reinforcement applied to the perimeter;

FIGS. 3A to 3E respectively show front views of further mesh panel variations on the embodiment of FIG. 1;

FIGS. 4A and 4B respectively show two different screening apparatus configurations incorporating the mesh panel of FIG. 1;

FIG. 5 shows a schematic cross-sectional view of a screening apparatus in operation with respect to a high pressure fluid leak from a hose/line; and

FIG. 6 shows a schematic cross-sectional view of a mesh sleeve located to surround a high pressure fluid leak from a hose/line.

### DETAILED DESCRIPTION OF SPECIFIC EMBODIMENTS

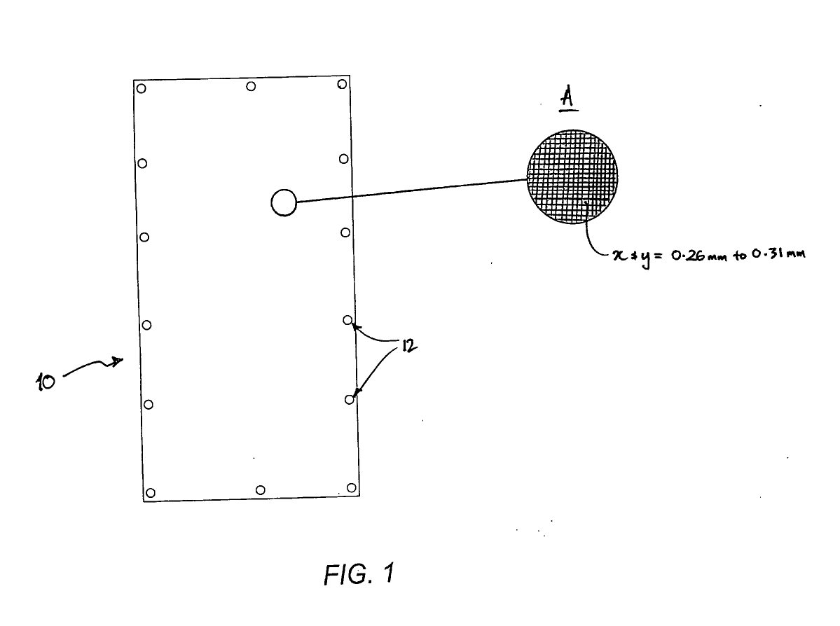

Referring firstly to FIG. 1, a first embodiment of a mesh is shown in the form of a mesh panel 10 that is suitable for use in a screening apparatus. The mesh panel 10 is adapted for screening a user from being directly impacted by a high pressure fluid such as a hydraulic fluid at a pressure of 5000 psi (or greater). More specifically, the mesh panel 10 is adapted for diffusing the high pressure fluid as it passes through the mesh. As a result of this diffusion the fluid's energy is dissipated/dispersed.

Furthermore, and especially when the fluid stream is in the form of a pinhole jet of fluid, the mesh panel 10 is adapted such that, as the pinhole fluid jet passes through the mesh its fluid profile is dissipated/dispersed. Pinhole fluid injection into a user can thus be eliminated, so that death and serious injury of the user can be eliminated. This of course assumes that the user is wearing protective clothing and eyewear so that user spraying by the diffused hydraulic fluid is still protected against.

The mesh of panel 10 is usually formed from a woven metal wire, to provide dimensional stability, environmental resistance and robustness in industrial applications. It is noted that for certain lower fluid pressures (e.g. hydraulic fluid pressures in the range of 350-750 psi) a woven polymer mesh (e.g. of Kevlar or the like) or meshes of other woven materials may be considered, but in heavy industrial applications where high fluid pressure are required then metal meshes are favoured. Particularly in applications where there exist high levels or moisture or corrosive media (acidic waters in underground mines) the mesh can be formed from a moisture and corrosive-resistant metal such as stainless steel, and metal meshes of copper, galvanised steel, etc may also be suitable in certain such applications.

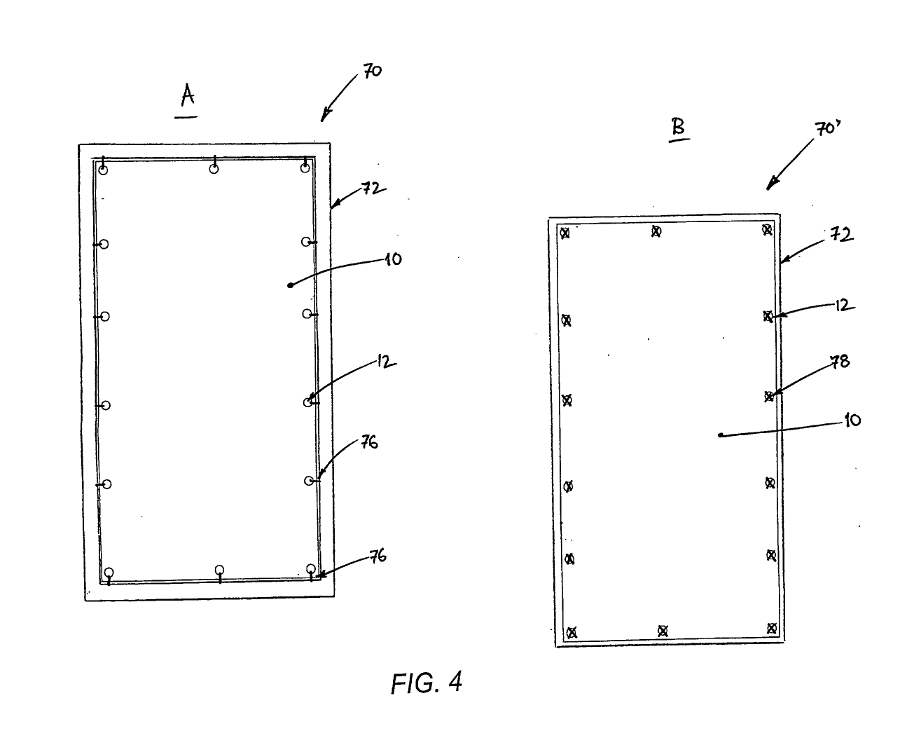

The panel 10 is provided with a series of holes in the form of eyelets 12 spaced apart along it edges for enabling fastening of the mesh to a frame (e.g. by bolting, screwing, riveting, wire-tying etc)—see FIGS. 4A and 4B. For example, the entire panel or at least the edge(s) of the mesh can be reinforced with a polymeric rubber that is attached (e.g. moulded, adhered, cold-rolled etc) thereat. The mesh can also be provided with a series of holes (e.g. eyelets) along it edge(s) for enabling its fastening to the frame (e.g. by bolting, tying, staple toggles etc).

Usually the entire mesh comprises a polymeric rubber coating on at least one but typically on both sides thereof. This can provide for maximum mesh protection, product integrity and wear-resistance during ordinary use (e.g. handling, installation, when contacted by users and machinery, when impacted by flying debris, etc). The polymeric rubber coating also allows the mesh to be adequately restrained and stabilised (e.g. when mounted to a frame) and enhances the hang strength of the mesh panel. However, at high pressure fluid impact, the rubber coating simply disintegrates to expose the mesh, with fluid diffusion then occurring as the fluid travels through the mesh.

The polymeric rubber is typically vulcanised to increase it strength, abrasion resistance etc. A particularly suitable rubber is vulcanised and calendered styrene butadiene rubber (SBR) because of its fire-resistance, chemical-resistance, anti-static properties (especially important in underground applications of the panel), high tensile strength, abrasion resistance, and moderate ozone and ageing resistance. An alternative polymer rubber is a nitrile rubber (copolymer of acrylonitrile and butadiene).

A suitable rubber is supplied by Apex Fenner (rubber 2618 SBR), finding previous applications with pulleys and conveyor belting.

The polymeric rubber coating can be applied as a sheet to each side (e.g. the sheet can be adhesively fastened, hot-rolled or cold-rolled onto a respective side of the mesh) or it can be moulded thereto (e.g. by injection or rotor moulding etc). The coating method can also employ hot vulcanising, cold vulcanising or moulded vulcanising (as described below).

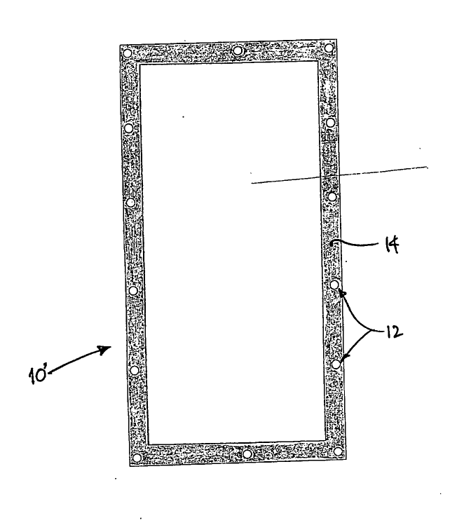

Referring now to FIG. 2, a variation on the panel 10 of FIG. 1 is shown as mesh panel 10′. In this panel just the edges of the mesh are reinforced for mounting and fastening with respect to a frame. The reinforcing protects the panel edges, and prevents mesh fraying at the edges and at eyelets 12. The edges are reinforced with a polymeric rubber 14 that is moulded or otherwise fastened around the edges (i.e. on both sides of the panel).

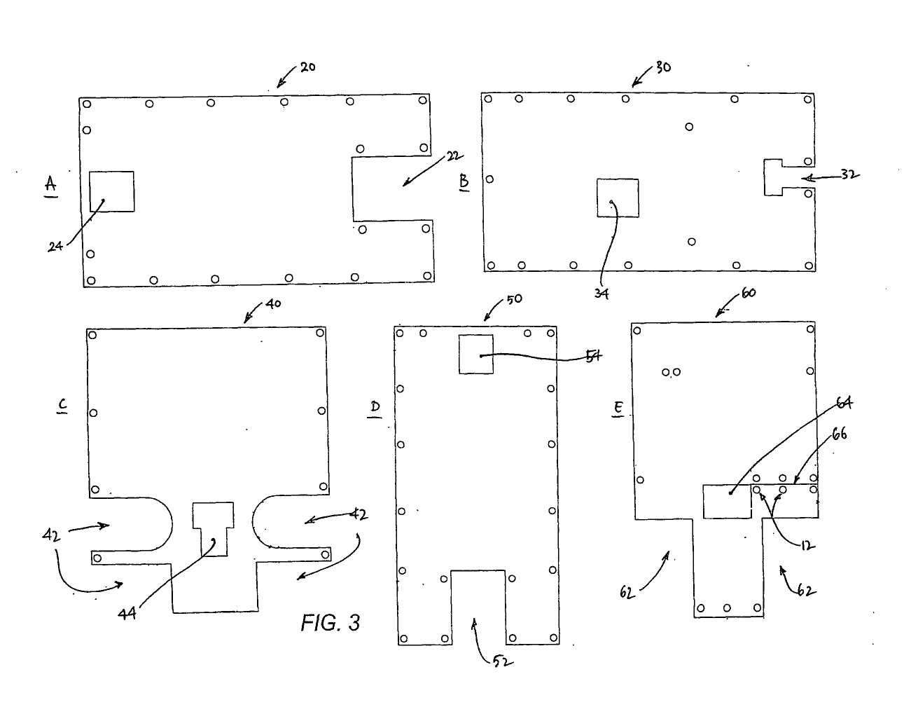

Referring now to FIGS. 3A to 3E, five different mesh panel configurations 20, 30, 40, 50 and 60 are shown. Each panel is shaped for positioning at a different respective location in relation to a user, so as to effectively screen the user from high pressure fluid impact.

In this regard, such a user may be an operator that operates drilling or tunnelling equipment in underground mining or tunnelling operations. Such equipment is typically powered by hydraulic fluid supplied at very high pressures (5000 psi or greater) via a series of high pressure fluid lines or hoses, which tend to surround and be positioned around a protective framework for the operator, such as a cage. The different mesh panel configurations 20, 30, 40, 50 and 60 are shaped for mounting at different parts of the cage. For example, each panel comprises cut-outs 22, 32, 42, 52 and 62 at one or more edges thereof, for close positioning next to equipment located at the cage. Also, each panel comprises an aperture 24, 34, 44, 54 and 64 therethrough for equipment etc access. The aperture 64 also has a slit 66 for passing an equipment part into the aperture, and that is closed once the panel is mounted, by fastening at the adjacent close-spaced eyelets 12. The panels can be customised as user and machinery requirements dictate.

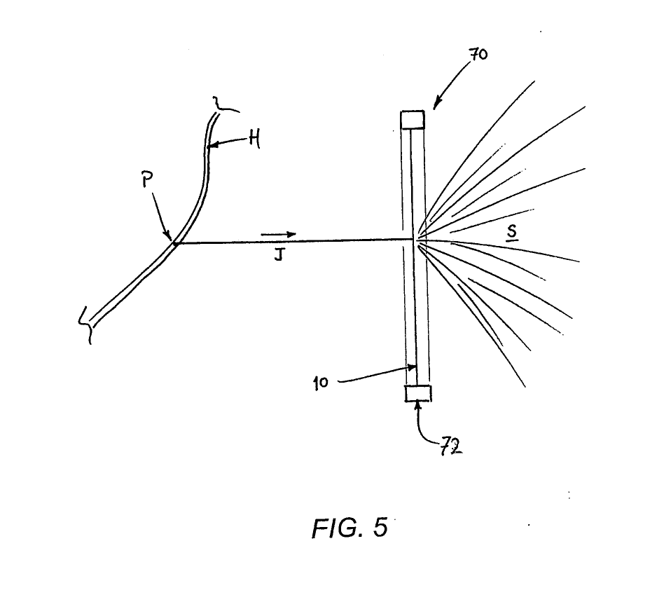

Referring now to FIGS. 4A, 4B and 5, a screening apparatus 70, 70′ is shown that comprises a frame 72 for supporting the mesh panel 10 at a location that is spaced with respect to a high pressure fluid line 74 (FIG. 5).

In the screening apparatus 70 of FIG. 4A the mesh panel 10 is located within the perimeter of frame 72 and is mounted thereto by wire ties 76.

In the screening apparatus 70′ of FIG. 4B the mesh panel 10 is located against the perimeter of frame 72 and is mounted thereto by bolts, screws, rivets, or toggle latches 78.

The frame 70, 70′ can be arranged at and/or can form part of a cage for screening an operator. The operator can operate drilling or tunnelling equipment in underground mining or tunnelling operations.

Referring specifically to FIG. 5 a high pressure pinhole fluid jet J is shown issuing out of a pinhole P in a high pressure fluid hose or line H. The jet is shown impacting and passing through the apertures of the mesh panel 10 and, as it passes, diffusing/dispersing as a spray stream S. Thus, the fluid profile of the jet J is dissipated/dispersed, as is the energy (force) of the jet.

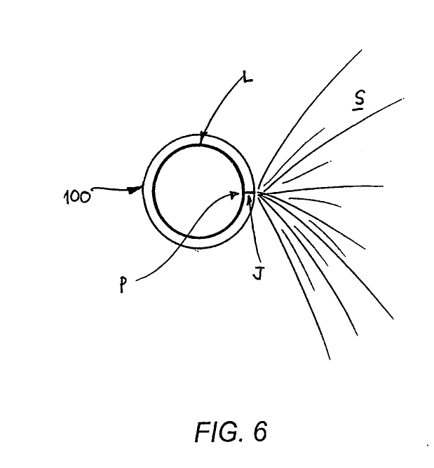

Referring now to FIG. 6, an alternative embodiment of a mesh is shown in the form of a mesh sleeve 100 that has been suitably positioned to surround a high pressure fluid line L such as a hose, pipe or tube. The sleeve can also be sized to surround bundles (e.g. bonded sets) of high pressure hoses. Edges of the sleeve are overlapped at the sleeve join so as not to represent an potential area of weakness.

When positioned to surround a high pressure fluid line L, again the mesh sleeve 100 can screen a user from being directly impacted by a high pressure fluid that leaks from the line 102 (e.g. as a pinhole hydraulic fluid jet at a pressure of 5000 psi or greater). Again, the mesh sleeve 100 is adapted for diffusing the high pressure fluid as it passes through the mesh. As a result of this diffusion the fluid's energy is dissipated/dispersed and death/injury prevented.

In this regard, in FIG. 6 a high pressure pinhole fluid jet J is shown issuing out of a pinhole P in a high pressure fluid line L. The jet is shown impacting and passing through the apertures of the mesh sleeve 100 and, as it passes, diffusing/dispersing as a spray stream S. Thus, the fluid profile of the jet J is dissipated/dispersed, as is the energy (force) of the jet.

The mesh sleeve 100 is schematically shown as being spaced from the high pressure fluid line L, to illustrate the diffusion of jet J. In practice, the sleeve 100 would typically be closely located against the high pressure fluid line L.

### EXAMPLE 1

A non-limiting Example of forming a panel as disclosed herein will now be provided.

In the panel forming process a mesh comprising a market grade (316 grade) woven stainless steel mesh was cut to an approximate panel size of 1000 mm×1500 mm. A process of hot vulcanising an SBR rubber sheet of approximately 1.5 mm thickness onto the mesh comprised the following steps:

1. The mesh and the suitably sized SBR rubber sheet were brushed with a cement bonding solution. A suitable bonding solution employed was a “two-pack” rubber cement of Toyo Tyre & Rubber having the manufacturer's code F2444 (UN No. 1287).

2. The solution was allowed to “tact” off (i.e. go tacky).

3. The rubber sheet was applied to one side of mesh.

4. Steps 1-3 were repeated for the other side of the mesh with another suitably sized SBR sheet.

5. The product from 4, was clamped and autoclave cured (at 150° C. and at a pressure 400 kPa). The autoclave curing time was approximately 30 mins.

6. Sections of the resulting cured screen were then “buff overlapped”.

7. The screen was washed down with a chemical cleaner to remove any excess rubber and glue contaminants.

8. As desired a stencil was applied a label was painted on the finished product.

The forms of vulcanising that were able to be employed included hot vulcanising (using heat and pressure to bond the rubber onto the mesh); cold vulcanising in which the rubber was bonded to the mesh by adhesive only; and moulded vulcanising (which used heat and pressure to bond the rubber onto the mesh, and employed moulds and tooling to facilitate the process).

### EXAMPLE 2

A non-limiting Example of the mesh in use in accordance with the screening method disclosed herein will now be provided.

Firstly, a mesh for the mesh panel was selected that was suitable for screening against a hydraulic fluid comprising a water-based mixture with mineral oil, (95% water, 5% mineral oil).

In an underground mining and tunneling trial, it was noted that such a fluid was subjected to high fluid pressures of up to 5000 psi (and sometimes 6000 psi) in fluid lines used to power much of the mining and tunneling equipment. This included fluid lines to the stage loaders, belt headings, roof supports, and cutting machines and shearers. It was observed in a typical longwall mining operation that around 9500 high fluid pressure fluid lines were employed across a longwall of approximately 250 m width and 3 km length. It was further noted that the most common form of fluid line failure was a so-called pinhole failure, whereby an approximately 2 mm pinhole jet ejected forth at high pressure. If the jet were to pierce into a human user, fluid flow into the body cavity was observed to be as much as 20 litres/sec.

The mesh selected comprised a market grade (316 grade) woven stainless steel mesh of an approximate panel size 1000 mm×1500 mm. Such stainless steel mesh was observed to be readily available and suitable for use in the usual wet and corrosive conditions often present in underground mining and tunneling operations. Stainless steel was also observed to be washable for servicing of the screening apparatus.

To determine the mesh aperture size a selection protocol involved optimising the mesh aperture to produce a maximum diffusion effect for the given fluid, the given fluid pressure, and a likely rupture scenario in the given application.

For a hydraulic fluid comprising a water-based mixture with mineral oil, at a pressure of approximately 5000 psi, an optimal mesh aperture size was selected to be in the range of 0.25 mm or greater. For a similar hydraulic fluid at a pressure of approximately 6000 psi, an optimal mesh aperture size was selected to be in the range of 0.3 mm or greater.

In practice, for the 316 grade woven stainless steel mesh, an optimal aperture size range for the hydraulic fluid at a pressure of approximately 5000 psi was observed to be 0.26 to 0.31 mm (ie. x and y dimensions generally both the same and within this range, as depicted in FIG. 1A). An optimal wire diameter to produce an aperture size of 0.26 mm was 0.16 mm, and an optimal wire diameter to produce an aperture size of 0.31 mm was 0.2 mm. For hydraulic fluid at a pressure of approximately 6000 psi, optimal aperture size was observed to be 0.31 to 0.415 mm (ie. x and y dimensions generally both the same and within this range). An optimal wire diameter to produce an aperture size of 0.31 mm was 0.2 mm, and an optimal wire diameter to produce an aperture size of 0.415 mm was 0.22 mm.

It was further observed that when the aperture size was less than 0.25 mm then the mesh tended to restrict fluid flow therethrough, to the point where back-pressure caused the mesh to rupture. It was also observed that when an aperture size was selected that was considerably greater than 0.3 mm then the mesh did not function to sufficiently diffuse the pinhole jet of fluid, whereby the fluid was able to retain its energy and human injury would still result.

In the method a number of the mesh screens (FIGS. 1 to 4) were mounted to an operator's operating cage, using techniques similar to those illustrated in FIGS. 4A and 4B. The mounting locations corresponded to the mesh panels being spaced from but located with respect to each of the high pressure fluid lines in the vicinity of the cage, so that the mesh was able to receive and diffuse any resultant pinhole jets of high pressure fluid as it passed through the mesh.

Also in the method a number of the mesh sleeves (FIG. 6) were mounted to hoses located in the vicinity of various operators, again so that each mesh sleeve was able to receive and diffuse any resultant pinhole jets of high pressure fluid as it passed through the sleeve. The sleeves were able to be sized to surround bundles (bonded sets) of high pressure hoses (e.g. three of more hoses in a bundle). The sleeve was also able to be attached at the point of assembly of the bonded sets.

In a number of trials, a pinhole was formed in a high pressure fluid line not under any pressure and then high pressure was applied to the fluid therein. A pinhole fluid jet of fluid of around 2 mm diameter ejected out of the pinhole and was allowed to pass through the mesh of an adjacent panel or sleeve. In each case the jet was observed to diffuse on leaving the panel or sleeve. In this regard, a sampling screen or sampling object (e.g. a cut of meat from a non-human animal) positioned on the other side of the mesh revealed that both the jet's energy (force) and its profile were significantly dissipated/dispersed.

Whilst a number of embodiments of the screening apparatus, mesh panel, mesh sleeve and method have been described, it will be appreciated that these can be embodied in many other forms.

For example, it should be noted that the high pressure fluid can issue from other sources, such as leakages in pipe/tube couplings and joiners, from hydraulically or pneumatically powered equipment itself, from other conduits carrying pressured fluid etc. Also, whilst the mesh material typically comprised stainless steel wire woven into a mesh form, the mesh material was able to be selected to be suitable to the given application whilst still producing the diffusion/dispersion effect. For example, other “inert” metals such as copper or galvanised steel could be employed for the mesh. Also high strength polymers may be applicable in some low pressure fluid applications.

Also, when the location is a high pressure hose, pipe or tube, the high pressure fluid was typically a hydraulic fluid (e.g. a synthetic compound, a mineral oil, water, or a water-based mixture) at pressures of many thousands of psi. However, in other applications the fluid may alternatively comprise a high pressure gas, or another pressurised liquid not necessarily being employed to power hydraulic equipment.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments.

1. A mesh for use in screening a user from direct impact of a high pressure fluid, the mesh being adapted for receiving and diffusing the high pressure fluid therethrough when positioned in relation to a location from which the high pressure fluid issues.

2. A mesh as claimed in claim 1 that has the form of:
a panel that has a spaced relationship to the location from which the high pressure fluid issues; or
a sleeve that can be closely positioned to the location from which the high pressure fluid issues.

3. A mesh as claimed in claim 2 wherein, when the mesh has the form of a panel, it is adapted for being supported at a frame.

4. Screening apparatus for screening a user from direct impact of a high pressure fluid, the apparatus comprising:
a mesh arranged and adapted for receiving and diffusing the high pressure fluid therethrough; and
a frame for supporting the mesh in a spaced relationship to a location from which the high pressure fluid issues.

5. A mesh or apparatus as claimed in claim 3 or 4 wherein the entire mesh or edge(s) of the mesh are reinforced for fastening with respect to the frame.

6. A mesh or apparatus as claimed in claim 5 wherein the mesh is reinforced with a polymeric rubber.

7. A mesh or apparatus as claimed in any one of the preceding claims wherein the mesh is coated or moulded on one or both sides with a polymeric rubber.

8. A mesh or apparatus as claimed in any one of claims 3 to 7 wherein the frame forms part of a cage for screening the user in use.

9. A mesh or apparatus as claimed in any one of claims 3 to 8 wherein the mesh has a series of holes along its edge(s) for enabling its fastening to the frame.

10. A mesh or apparatus as claimed in any one of the preceding claims wherein the mesh is formed from metal wire.

11. A mesh or apparatus as claimed in any one of the preceding claims wherein the mesh is formed from woven stainless steel wire.

12. A mesh or apparatus as claimed in any one of the preceding claims wherein the mesh aperture size is around 0.25 mm or greater.

13. A mesh or apparatus as claimed in claim 12 wherein, for a fluid pressure of around 5000 psi, the mesh aperture size is in the range of 0.26-0.31 mm, and for a fluid pressure of around 6000 psi, the mesh aperture size is in the range of 0.31-0.415 mm.

14. A mesh or apparatus as claimed in any one of the preceding claims wherein the location from which the high pressure fluid issues is a hole in a high pressure hose, pipe or tube.

15. A mesh or apparatus as claimed in any one of the preceding claims wherein the high pressure fluid is a hydraulic fluid at a pressure of around 5000 psi or greater.

16. A method for screening a user from direct impact of a high pressure fluid, the method comprising the step of diffusing the fluid at a first location that is spaced with respect to a second location from which the high pressure fluid issues.

17. A method as claimed in claim 16 wherein the first location is closely spaced with respect to the second location.

18. A method as claimed in claim 16 or 17 wherein a mesh is positioned at the first location such that the mesh receives and diffuses the high pressure fluid therethrough.

19. A method as claimed in claim 18 wherein the mesh is supported at the first location by mounting it to a frame.

20. A method as claimed in claim 20 wherein the frame is arranged at a cage that at least partially surrounds the user in use.

21. A method as claimed in any one of claims 16 to 20 wherein, for a given fluid, the mesh aperture size is selected so as to cause the high pressure fluid to be diffused therethrough.

22. A method as claimed in claim 21 wherein the mesh aperture size is selected to be around 0.25 mm or greater.

23. A method as claimed in claim 22 wherein, for a high pressure hydraulic fluid at a pressure of around 5000 psi, the mesh aperture size is selected to be in the range of 0.26-0.31 mm, and for a fluid pressure of around 6000 psi, the mesh aperture size is in the range of 0.31-0.415 mm.

24. A method as claimed in any one of claims 16 to 23 wherein the mesh material selected is stainless steel wire that is woven to form the mesh.

25. A method as claimed in any one of claims 16 to 24 wherein the location from which the high pressure fluid issues is a hole in a high pressure hose, pipe or tube, whereby the diffusion can be effected at or remotely from the hose, pipe or tube.

26. A method as claimed in any one of claims 16 to 25 that employs the mesh or screening apparatus as claimed in any one of claims 1 to 10.
